(19) United States
(12) Patent Application Publication
(10) Pub. No.: US 2026/0241501 A1
(43) Pub. Date: Aug. 20, 2026

(54) MACHINE TOOL SYSTEM WITH PRE-LOADED PLUNGER CLAMP MECHANISM

(71) Applicant: Rolls-Royce Corporation, Indianapolis, IN (US)

(72) Inventor: Rusty Garner, Indianapolis, IN (US)

(21) Appl. No.: 19/056,689

(22) Filed: Feb. 18, 2025

(51) Int. Cl. B23Q 3/06

(52) U.S. Cl. CPC B23Q 3/06; B23Q 2703/02

(57) ABSTRACT

A machine tool system includes a workpiece, a machine for modifying the workpiece, and a tool base. The tool base supports the workpiece. The tool base includes first and second support frames repositionable on a base platform. The first support frame holds the workpiece, and the second support frame can be moved up to and against the workpiece to further secure it in position. The second support frame includes a plunger clamp having a movable plunger rod and spring-loaded rod movable relative to the plunger rod. The plunger rod is movable between an unlocked arrangement in which the spring- loaded rod is pressed against the workpiece and can move so as to allow for some adjustment of the workpiece positioning, and a locked arrangement in which the plunger rod is moved forward and secured against the workpiece to completely lock it into place.

### FIELD OF THE DISCLOSURE

The present disclosure relates generally to machine tool systems, and more specifically to workpiece supports of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

According to a first aspect of the present disclosure, a machine tool system comprising a thin-walled three-dimensional workpiece, a machine configured to modify the thin-walled three-dimensional workpiece, the machine including a shaft configured to move along a first axis, and a tool base. The tool base is configured to support the thin-walled three-dimensional workpiece and spaced apart from the shaft along the first axis and repositionable relative to the shaft. The shaft is movable relative to the tool base so as to modify the thin- walled three-dimensional workpiece, the tool base including a base platform, a first support frame that is repositionable on the base platform and configured to support the thin-walled three-dimensional workpiece above the base platform, and a second support frame that is repositionable on the base platform, the second support frame including a plunger clamp coupled thereto, the plunger clamp including a clamp base, a plunger rod movably supported by the clamp base and extending away from the clamp base, the plunger rod being selectively movable toward and away from the clamp base, the plunger clamp further including a spring-loaded rod that is movable relative to the plunger rod, a forwardmost end of the spring-loaded rod extending forward of a forwardmost end of the plunger rod in response to the plunger rod being in an unlocked arrangement.

In some embodiments, the second support frame is configured to be repositioned adjacent to the first support frame such that the plunger clamp contacts the thin-walled three-dimensional workpiece and provides support thereto. In response to the plunger rod being selectively moved to the unlocked arrangement, the forwardmost end of the spring-loaded rod contacts the thin- walled three-dimensional workpiece while allowing for some play of the thin- walled three-dimensional workpiece relative to the tool base so as to allow for adjustments of the thin-walled three-dimensional workpiece relative to the shaft of the machine. In response to the plunger rod being selectively moved to a locked arrangement, the forwardmost end of the plunger rod is moved forward and contacts the thin-walled three-dimensional workpiece to lock the thin-walled three-dimensional workpiece in an immovable position relative to the shaft of the machine.

In some embodiments, the plunger rod further includes a spring coupled to the spring-loaded rod and configured to bias the spring-loaded rod forward of the forwardmost end of the plunger rod in the unlocked arrangement.

In some embodiments, the plunger rod further includes a support portion having a support surface that faces the forwardmost end of the plunger rod, a first end of the spring is coupled to and supported against the support surface, and the spring-loaded rod is arranged on a second end of the spring opposite the first end.

In some embodiments, the plunger rod includes a distal portion that extends away from the support portion, and the spring-loaded rod is coaxial with the distal portion and is movable relative to the distal portion.

In some embodiments, the distal portion includes at least one elongated opening formed therein, the spring-loaded rod includes at least one pin that extends through the at least one elongated opening, and the at least one elongated opening is sized so as to delimit movement of the spring-loaded rod in a forward direction as the spring-loaded rod is biased by the spring.

In some embodiments, the support portion is formed as an annular flange that extends outwardly away from the plunger rod, and the distal portion of the plunger rod extends away from a central portion of the support surface of the support portion such that an area of the support surface outward of the central portion defines the area on which the spring is coupled.

In some embodiments, the spring-loaded rod includes a central cavity extending through the spring-loaded rod and through which the distal portion of the plunger rod extends, the spring-loaded rod is slidable relative to the distal portion.

In some embodiments, the forwardmost end of the plunger rod is a forwardmost end of the distal portion, the spring-loaded rod includes a forward opening aligned with the central cavity, the forwardmost end of the distal portion extends through the forward opening in response to the plunger rod being moved to the locked arrangement, and the forwardmost end of the distal portion is arranged within the central cavity of the spring-loaded rod rearward of the forward opening in response to the plunger rod being in the unlocked arrangement.

In some embodiments, the distal portion of the plunger rod extends away from the support surface of the support portion and includes a central cavity extending through the distal portion from the support surface to a forwardmost end of the distal portion and opening at a forward opening located at the forwardmost end, and the spring-loaded rod is arranged within the central cavity and is slidable therein.

In some embodiments, the forwardmost end of the spring-loaded rod extends outwardly from the central cavity of the distal portion forward of the forward opening of the distal portion in response to the plunger rod being in the unlocked arrangement.

In some embodiments, the plunger clamp further includes a lever configured to move the plunger rod away from and toward the clamp base, the lever is selectively movable between an unlocked position which moves the plunger rod to the unlocked arrangement and a locked position which moves the plunger rod to the locked arrangement.

According to a further aspect of the present disclosure, a machine tool system includes a workpiece, a machine configured to modify the workpiece, and a tool base configured to support the workpiece relative to the machine and repositionable relative to the machine, the tool base including a first support frame supporting the workpiece and a second support frame that is repositionable relative to the first support frame and including a plunger clamp coupled thereto, the plunger clamp including a clamp base, a plunger rod movably supported by the clamp base, and a spring-loaded rod that is movable relative to the plunger rod.

In some embodiments, in response to the plunger rod being selectively moved to an unlocked arrangement, only a forwardmost end of the spring-loaded rod contacts the workpiece while allowing for some play of the workpiece relative to the machine, and, in response to the plunger rod being selectively moved to a locked arrangement, a forwardmost end of the plunger rod is moved forward and contacts the workpiece to lock the workpiece in an immovable position relative to the machine.

In some embodiments, the forwardmost end of the spring-loaded rod extends forward of the forwardmost end of the plunger rod in response to the plunger rod being in the unlocked arrangement.

In some embodiments, the plunger rod further includes a support portion having a support surface that faces the forwardmost end of the plunger rod, a first end of the spring is coupled to and supported against the support surface, the spring-loaded rod is arranged on a second end of the spring opposite the first end, the plunger rod includes a distal portion that extends away from the support portion, and the spring-loaded rod is coaxial with the distal portion and is movable relative to the distal portion.

In some embodiments, the support portion is formed as an annular flange that extends outwardly away from the plunger rod, the distal portion of the plunger rod extends away from a central portion of the support surface of the support portion such that an area of the support surface outward of the central portion defines the area on which the spring is coupled, the spring-loaded rod includes a central cavity extending through the spring-loaded rod and through which the distal portion of the plunger rod extends, and the spring-loaded rod is slidable relative to the distal portion.

In some embodiments, the forwardmost end of the plunger rod is a forwardmost end of the distal portion, the spring-loaded rod includes a forward opening aligned with the central cavity, the forwardmost end of the distal portion extends through the forward opening in response to the plunger rod being moved to the locked arrangement, and the forwardmost end of the distal portion is arranged within the central cavity of the spring-loaded rod rearward of the forward opening in response to the plunger rod being in the unlocked arrangement.

In some embodiments, the distal portion of the plunger rod extends away from the support surface of the support portion and includes a central cavity extending through the distal portion from the support surface to a forwardmost end of the distal portion and opening at a forward opening located at the forwardmost end, the spring-loaded rod is arranged within the central cavity and is slidable therein, and the forwardmost end of the spring-loaded rod extends outwardly from the central cavity of the distal portion forward of the forward opening of the distal portion in response to the plunger rod being in the unlocked arrangement.

According to a further aspect of the present disclosure, a method includes providing a workpiece, providing a machine configured to modify the workpiece, arranging the workpiece in a first support frame of a tool base, the workpiece being allowed some play relative to the machine when only arranged in the first support frame, the tool base including the first support frame and a second support frame that is repositionable relative to the first support frame and including a plunger clamp coupled thereto, the plunger clamp including a clamp base, a plunger rod movably supported by the clamp base, and a spring-loaded rod that is movable relative to the plunger rod. The method further includes selectively moving the plunger rod to an unlocked arrangement in which a forwardmost end of the spring-loaded rod is positioned forward of a forwardmost end of the plunger rod, moving the second support frame proximal to the first support frame such that the forwardmost end of the spring-loaded rod contacts the workpiece while allowing for some play of the workpiece relative to the machine, and selectively moving the plunger rod to a locked arrangement in which forwardmost end of the plunger rod is moved forward and contacts the workpiece to lock the workpiece in an immovable position relative to the machine.

In some embodiments, the method further includes, prior to moving the second support frame proximal to the first support frame such that the forwardmost end of the spring-loaded rod contacts the workpiece, adjusting at least one of a position of the first support frame or a position of the workpiece within the first support frame such that the workpiece is arranged in a first position relative to the machine.

In some embodiments, the method further includes, after moving the second support frame proximal to the first support frame such that the forwardmost end of the spring-loaded rod contacts the workpiece, further adjusting at least one of a position of the first support frame or a position of the workpiece within the first support frame such that the workpiece is arranged in a second position relative to the machine. In some embodiments, the selective moving of the plunger rod to the locked arrangement occurs after the workpiece has been adjusted to the second position.

These and other features of the present disclosure will become more apparent from the following description of the illustrative embodiments.

### BRIEF DESCRIPTION OF THE DRAWINGS

FIG. 1 is a perspective view of a machine tool system according to the present disclosure, showing that the system includes a workpiece, a machine configured to modify the workpiece, and a tool base having a first support frame and a second support frame including a plunger clamp having a plunger rod with a spring-loaded rod arranged thereon and movable relative thereto, the plunger rod being selectively movable between an unlocked arrangement in which the spring-loaded rod can be positioned against the workpiece so as to allow some play of the workpiece and a locked arrangement in which the plunger rod is positioned against the workpiece so as to immovably lock the workpiece in position;

FIG. 2 is a perspective view of the plunger clamp of FIG. 1, showing that the plunger clamp includes a clamp base, the plunger rod being movably supported by the clamp base and extending away from the clamp base, and the plunger rod being selectively movable toward and away from the clamp base, the plunger clamp further including the spring-loaded rod, and showing that the spring-loaded rod is hollow and arranged on a distal portion of the plunger rod and is movable relative thereto;

FIG. 3 is a top view of the tool base of FIG. 1, showing the first support frame having the workpiece initially mounted thereon being arranged in a first position and the second support frame having the plunger clamp being arranged in a second position relative to the first support frame;

FIG. 4A is side view of the first support frame of FIG. 1 supporting the workpiece;

FIG. 4B is a side view of the second support frame of FIG. 1 having the plunger clamp;

FIG. 5 is a top view of the plunger clamp of FIG. 2, showing that the clamp base includes a lever configured to move the plunger rod away from and toward the clamp base, the lever being selectively movable between an unlocked position which moves the plunger rod to the unlocked arrangement and a locked position which moves the plunger rod to the locked arrangement;

FIG. 6 is a bottom view of the plunger clamp of FIG. 2, showing the bottom of the clamp base;

FIG. 7 is a side view of the plunger clamp of FIG. 2, showing a forwardmost end of the spring-loaded rod arranged against the workpiece so as to allow some play of the workpiece, and showing the lever of the plunger clamp in the unlocked position such that the plunger rod is in the unlocked arrangement;

FIG. 8 is a side view of the plunger clamp of FIG. 2, showing a forwardmost end of the plunger rod arranged against the workpiece so as to lock the workpiece in an immovable position, and showing the lever of the plunger clamp in the locked position such that the plunger rod is in the locked arrangement;

FIG. 9 is a perspective view of a plunger rod of a plunger clamp according to a further aspect of the present disclosure, showing a plunger rod extending away from a clamp base and movable relative thereto, the plunger rod being hollow and including a spring-loaded rod slidably arranged therein, the plunger rod being selectively movable between an unlocked arrangement in which the spring-loaded rod can be positioned against the workpiece so as to allow some play of the workpiece and a locked arrangement in which the plunger rod is positioned against the workpiece so as to immovably lock the workpiece in position;

FIG. 10 is a side view of the plunger rod of FIG. 9 in the unlocked arrangement in which the spring-loaded is arranged against the workpiece so as to allow some play of the workpiece; and

FIG. 11 is a side view of the plunger rod of FIG. 9 in the locked arrangement in which the plunger rod is arranged against the workpiece so as to lock the workpiece in an immovable position.

### DETAILED DESCRIPTION

For the purposes of promoting an understanding of the principles of the disclosure, reference will now be made to a number of illustrative embodiments illustrated in the drawings and specific language will be used to describe the same.

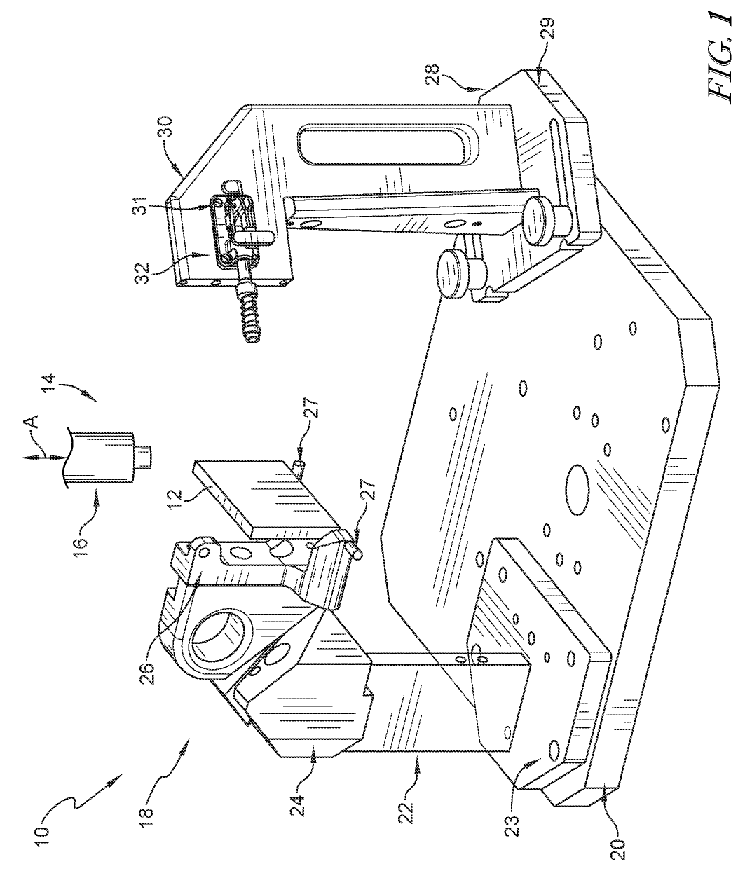

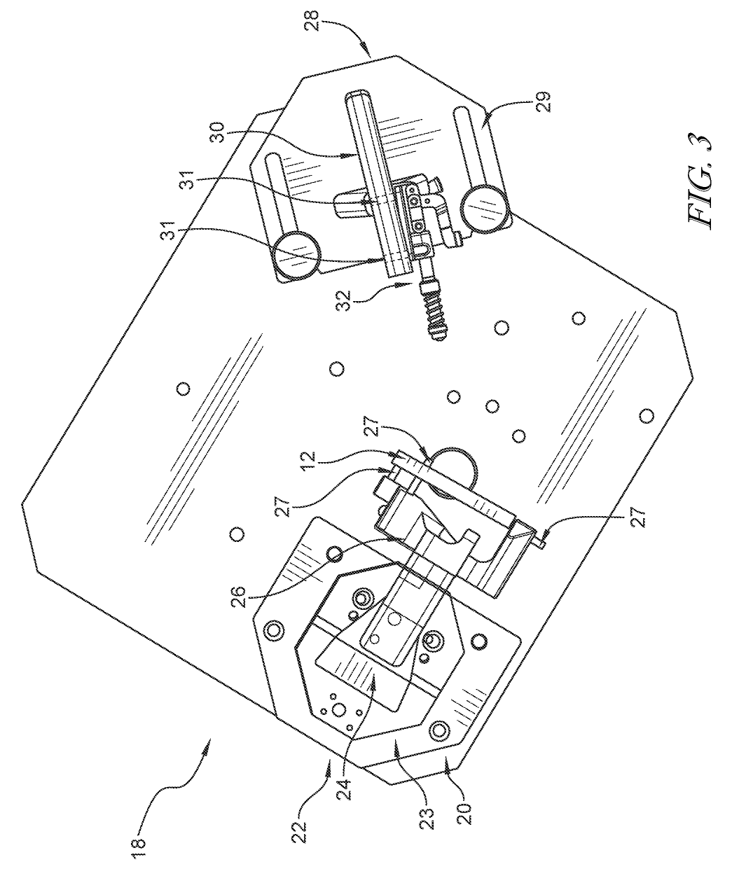

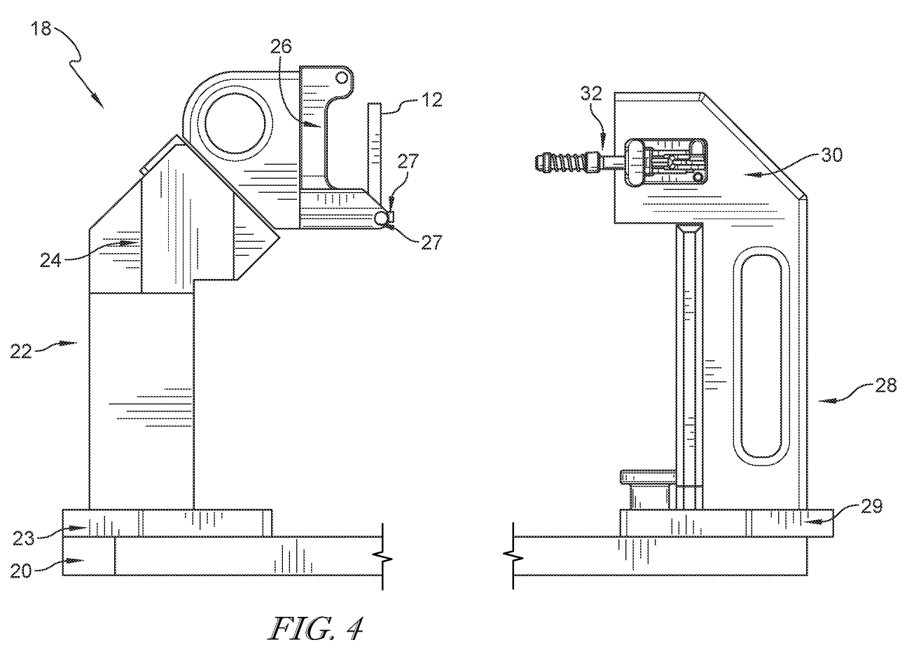

A machine tool system 10 includes a workpiece 12, a machine 14 having a shaft 16, and a tool base 18, as shown in FIGS. 1, 3, 4A, and 4B. In illustrative embodiments, the workpiece 12 is a thin-walled three-dimensional workpiece. The machine 14 is configured to modify the workpiece 12. As will be described below, components of the tool base 18, namely a first support frame 22 and a second support frame 28, support the workpiece 12 relative to the machine 14 and are repositionable and relocatable relative to the machine 14 in different positions. The workpiece 12 remains relatively stationary on the first and second frame elements 22, 28 such that repositioning of the first and second frame elements 22, 28 on the machine 14 also repositions the workpiece 12.

The machine 14 can include a shaft 16, as shown in FIG. 1. The tool base 18 supports the workpiece 12 relative to the shaft 16. The shaft 16 is spaced apart from the tool base 18 and moves along a first axis A to modify the workpiece 12.

In some embodiments, the machine 14 is capable of pulsed electrochemical machining (PECM). In such an embodiment, the shaft 16 or bit attached to the shaft 16 may be referred to as a cathode. To modify the workpiece 12, the shaft 16 moves toward the workpiece 12 and oscillates along the first axis A, but does not contact the workpiece 12. Once the shaft 16 is adjacent the workpiece 12 to form a gap therebetween, an electrolyte is injected into the gap. The electrolyte acts as an electron transfer medium to facilitate anodic dissolution of the material of the workpiece 12 adjacent the shaft 16. In some embodiments, the electrolyte may be a salt-based solution. The electrolyte allows electrical current to flow between the shaft 16 and the workpiece 12. Any by-products, such as, for example, metal hydroxides or hydrogen gas, of the electrochemical process are then flushed away by the electrolyte. The shaft 16 illustratively has a shape inverse to that of the desired workpiece 12 shape. In some embodiments, the shaft 16 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 16 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc. A person skilled in the art will understand that, although the embodiments described herein refer to a machine 14 having a shaft 16, the machine 14 utilizing the tool base 18 described herein may not include a shaft 16 but may include other means of modifying the workpiece 12.

In some embodiments, the machine 14 is a single axis machine 14. In other words, the shaft 16 of the machine 14 only moves along the first axis A. Thus, to modify different sides of the workpiece 12, the workpiece 12 is repositioned such that the different sides may be modified by the shaft 16 moving along the first axis A. However, the workpiece 12 may be relatively thin and easily distorted or non-repositionable in conventional fixtures and any repositioning of the workpiece 12 itself may distort the workpiece 12. The tool base 18 of the present disclosure provides the ability to reposition the workpiece 12 relative to the machine 14, in particular relative to the shaft 16.

The workpiece 12 is illustratively a thin-walled three-dimensional workpiece, as shown in FIGS. 1, 3, 4A, and 4B. In some embodiments, the workpiece 12 may be used in a gas turbine engine. For example, the workpiece 12 may form a part of a vane or a blade of a gas turbine engine. The workpiece 12 may provide a coversheet for a pressure side and/or a suction side of a vane or a blade.

As shown in FIGS. 1, 3, 4A, and 4B, the tool base 18 includes a base platform 20 that is selectively positionable on the machine 14 and can be locked into place relative to the machine 14 such that the base platform 20 is immovable relative to the shaft 16. In some embodiments, the base platform 20 may be fixedly coupled to a lower surface of the machine 14 in order to hold the platform 20 in place relative to the machine 14. The tool base 18 further includes a first support frame 22 arranged on an upper surface of the base platform 20 which includes a lower base 23 that rests on the base platform 20 and an upper portion 24 having a workpiece holder 26.

The workpiece holder 26 includes a plurality of workpiece supports 27 that extend away from multiple points on the workpiece holder 26 and hold the workpiece 12 in place relative to the holder 26. The workpiece supports 27 may be formed as spring-loaded peg or cylinder that holds the workpiece 12 in a relatively secure position, but allows for some play of the workpiece 12 relative to the holder 26 so as to allow for small adjustments of the position of the workpiece 12 relative to the holder 26.

The first support frame 22 is selectively positionable on the base platform 20 and can be moved about the base platform 20 until a desirable position of the first support frame 22 relative to the shaft 16 of the machine 14 is determined. In some embodiments, the first support frame 22 may be secured to the base platform 20 once the support frame 22 is arranged in the desired position on the platform 20.

Similarly, the tool base 18 further includes a second support frame 28 arranged on the upper surface of the base platform 20 spaced apart from the first support frame 22. The second support frame 28 includes a lower base 29 that rests on the base platform 20 and an upper portion 30 having a plunger clamp 32 arranged thereon via fastening holes 31 in the upper portion 30.

The second support frame 28 is selectively positionable on the base platform 20 and can be moved about the base platform 20 until a desirable position of the second support frame 28 relative to the shaft 16 of the machine 14 is determined. In some embodiments, the second support frame 28 may be secured to the base platform 20 once the support frame 28 is arranged in the desired position on the platform 20.

Illustratively, the second support frame 28 is configured to be moved into a position proximal to the first support frame 22 such that the plunger clamp 32 engages the workpiece 12 so as to further support the workpiece 12 relative to the first support frame 22 and to the shaft 16. As will be described in greater detail below, a plunger rod 60 of the plunger clamp 32 is selectively moveable between an unlocked arrangement in which a spring-loaded rod 76 arranged on the plunger rod 60 engages the workpiece 12 and applies a force on the workpiece 12 that allows for some play of the workpiece 12 relative to the holder 26, and a locked arrangement in which the plunger rod 60 is moved forward and engages the workpiece 12 so as to lock the workpiece in an immovable position relative to the holder 26 and the shaft 16 of the machine 14. In other words, in the unlocked arrangement, the spring-loaded rod 76 applies a first force on the workpiece 12 while the workpiece 12 is supported by the holder 26 that allows repositioning or adjustment of the workpiece 12 relative to shaft 16, and, in the locked arrangement, the plunger rod 60 applies a second force on the workpiece 12 while the workpiece 12 is supported by the holder 26 that is greater than the first force and great enough to not allow for repositioning or adjustment of the workpiece 12 relative to shaft 16.

Being able to move the second support frame 28 toward the workpiece 12 and engage the workpiece 12 in two different arrangements, one that applies a first force that allows repositioning or adjustment of the workpiece 12 and the other that entirely locks the workpiece 12 in place, allows for additional adjustment options of the workpiece 12 once it is placed in the machine 14. For example, in many known workpiece support devices, the workpiece may not be adjustable once positioned within the machine, or may only be adjustable to a certain minimal degree while not allowing repositioning after the final position is set or locked into place. By utilizing the tool base 18 described herein, in some examples, the workpiece 12 can first be positioned in an initial position relative to the shaft 16 that is close to the final, ideal position, in particular by first moving the first support frame 22 to the desired position and then making minor adjustments to the workpiece 12 relative to the holder 26. Then, after the second support frame 28 is moved into position such that the plunger clamp 32 contacts the workpiece 12, further minor adjustments can be made to the workpiece 12 by repositioning the workpiece 12, this being enabled by the force applied by the spring-loaded rod 76 of the plunger clamp 32. Then, when the final position is confirmed, the plunger rod 60 can be locked into place against the workpiece 12 in order to positionally lock the workpiece 12 relative to the shaft 16.

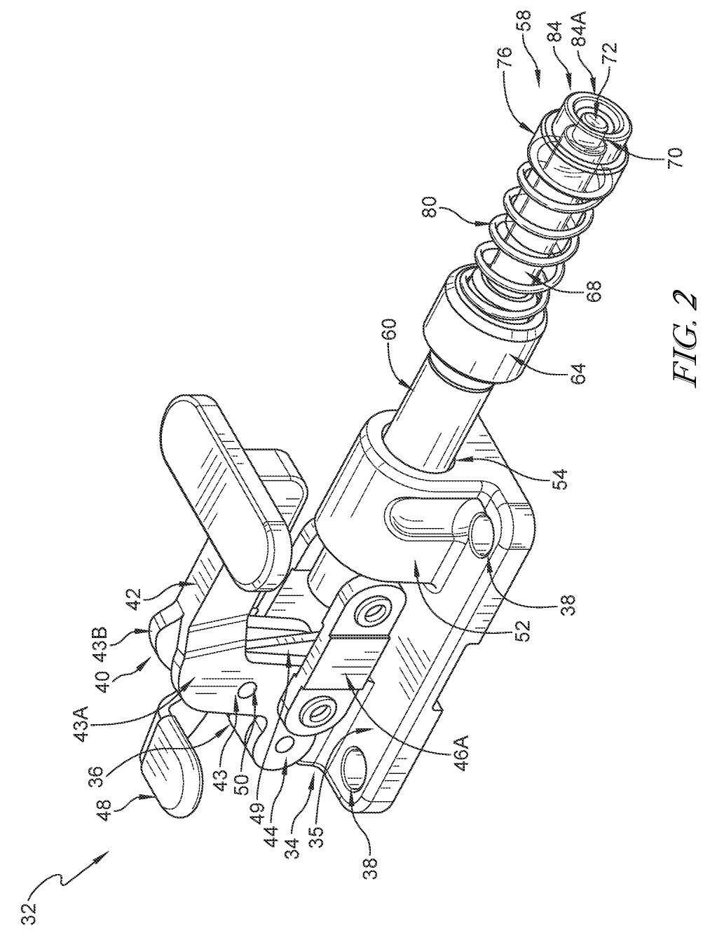

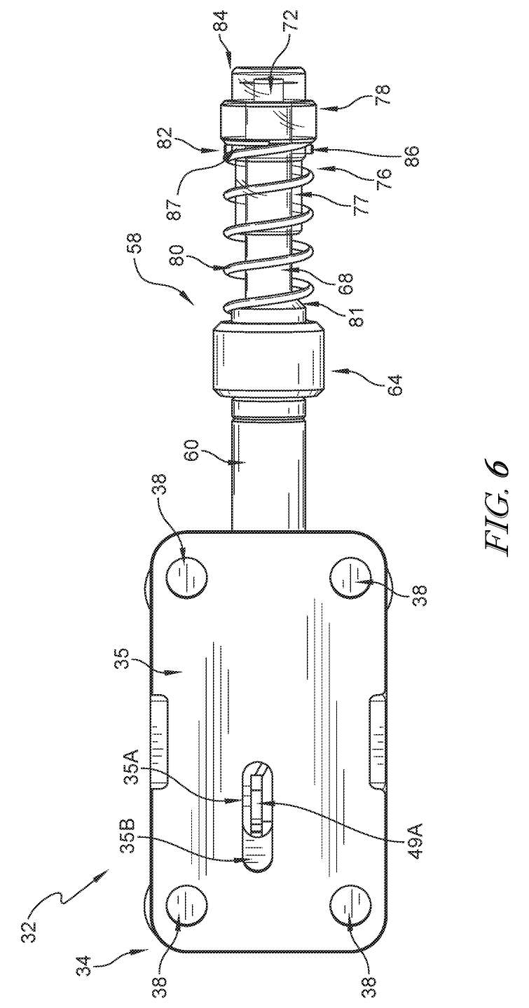

As shown in FIGS. 2 and 5-8, the plunger clamp 32 includes a base portion 34, a clamping portion 40, and a plunger portion 58 including the plunger rod 60. The base portion 34 includes a base 35 having a lever support protrusion 36 extending upwardly at a rear end of the base 35, and a plurality of fastener holes 38 that align with fastener holes 31 on the upper portion 30 of the second support frame 28 for coupling the plunger clamp 32 to the second support frame 28. It is noted that the figures show some components as transparent so that inner components can be viewed, such as the spring-loaded plunger 76.

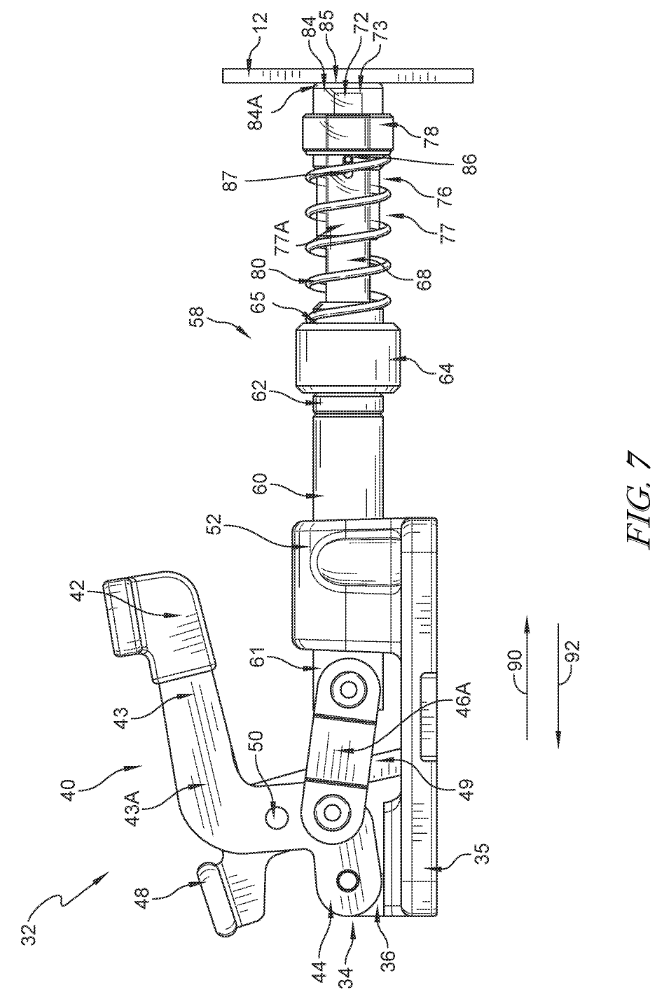

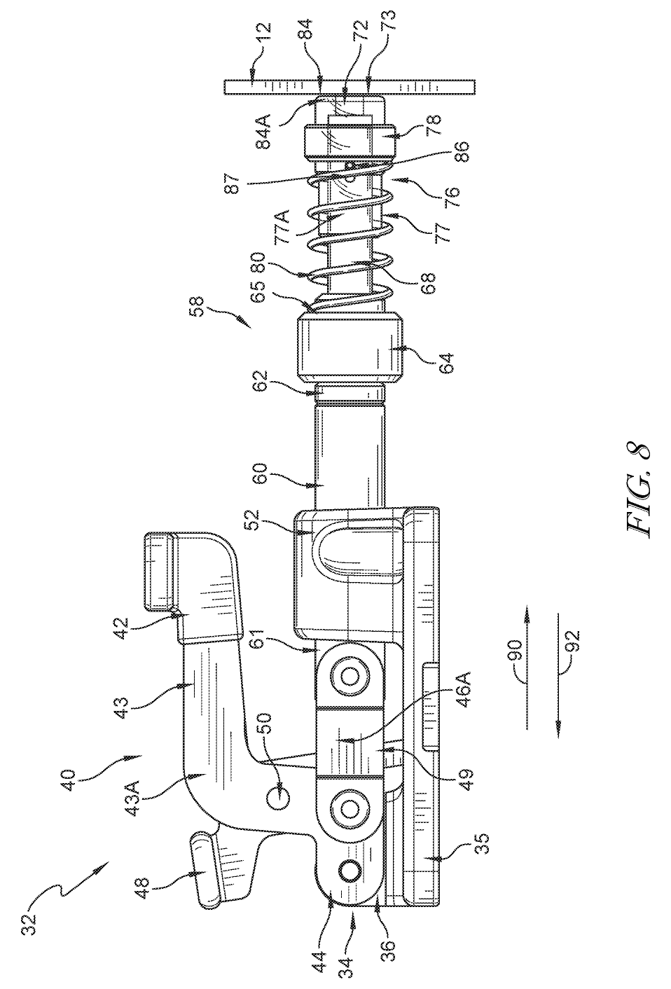

The base portion 34 further includes a pivot rod support protrusion 52 extending upwardly away from the base 35 at a forward end of the base 35 opposite the lever support protrusion 36, as shown in FIGS. 2 and 5-8. The pivot rod support protrusion 52 includes a cavity 54 extending therethrough that extends in the directions 90, 92 shown in FIGS. 7 and 8. The plunger rod 60 extends through the cavity 54 and is movable, in particular slidable, therein.

The lever portion 40 includes a first lever 42 that is pivotably coupled to the lever support protrusion 36 of the base 35, as shown in FIGS. 2 and 5-8. The lever 40 includes an upper portion 43 that splits into two elongated middle portion bars 43A, 43B that run parallel to each other, and a lower portion 44 pivotably coupled to the lever support protrusion 36. The lever portion 40 further includes a first connector 46A arranged on one of the elongated middle portion bars 43A and a second connector 46B arranged on the other of the elongated middle portion bars 43B. The connectors 46A, 46B are pivotably coupled to the elongated middle portion bars 43A, 43B at a position between the upper portion 43 and the lower portion 44. In some embodiments, the lever 42 bends at a generally orthogonal angle between the lower portion 44 and the elongated middle portion bars 43A, 43B, as shown in FIGS. 7 and 8.

A first end 46A1, 46B1 of each connector 46A, 46B is pivotably coupled to the lever 42, and a second end 46A2, 46B2 of each connector 46A, 46B is pivotably coupled to a first end 61 of the plunger rod 60 opposite a second end 62 of the rod 60, as shown in FIGS. 7 and 8. As such, when the lever 42 is raised upwardly away from the base 35 (i.e. arranged in an unlocked position), the connectors 46A, 46B pull the plunger rod 60 in a first direction 92 toward the base 35, as shown in FIG. 7. In this unlocked position, the plunger rod 60 is arranged in an unlocked arrangement in which the rod 60 can be arranged at a first distance from the base 35. In the unlocked arrangement, the plunger rod 60 is free to move in either the forward or rearward direction 90, 92. When manually moving the plunger clamp 32 toward the workpiece 12, a user can manually hold the lever 42 in place so as to hold the plunger rod 60 relatively stationary. Then, while holding the lever 42, the user can move the plunger clamp 32 into contact with the workpiece 12 such that the spring-loaded rod 76 contacts the workpiece 12. Accordingly, when the plunger clamp 32, and in particular the spring-loaded rod 76, are arranged against the workpiece 12 in the unlocked arrangement, the workpiece 12 can be adjusted while the spring-loaded rod 76 is in contact with the workpiece 12 and moving relative to the plunger rod 60. The spring-loaded rod 76 provides some pressure and force that keeps the workpiece 12 relatively stable, while also allowing for minor adjustments.

When the lever 42 is lowered toward the base 35 (i.e. arranged in the locked position), the connectors 46A, 46B push the plunger rod 60 in a second direction 90 away from the base 35, as shown in FIG. 8. In this locked position, the plunger rod 60 is arranged in a locked arrangement in which the rod 60 is a second distance from the base 35 greater than the first distance described above. In the locked arrangement, the plunger rod 60 is moved forward (direction 90) and into engagement with the workpiece 12 and essentially replaces the force being applied by the spring-loaded rod 76. This force is greater than the force that was applied by the spring-loaded rod 76, and is great enough to entirely lock the workpiece 12 in an immovable position relative to the shaft 16 of the machine 14.

The lever 42 may be locked by any known means, such as a cam or similar mechanical component arranged in or on the lower portion 44 of the lever 42, the lever support protrusion 36, within a pivot rod or fastener that pivotably couples the lever 42 to the lever support protrusion 36, and the like. The cam or similar mechanical component may engage a resistive component when moving into the locked position and can essentially snap into place after overcoming this resistive component.

Illustratively, the clamping portion 40 may further include a second lever 48 having an elongated bar 49 arranged between and pivotably coupled to the two elongated middle portion bars 43A, 43B at a pivot point 50, as shown in FIGS. 2, 5, 7, and 8. The second lever 48 further includes a hook 49A arranged on a lower side of the lever 48 that extends into an opening 35A formed in the base 35. The second lever 48 can be selectively rotated about the pivot point 50 such that, in order to lock the first lever 42 in the locked position and thus the plunger rod 60 in the locked arrangement, the second lever 48 is moved in the forward direction 90 such that the hook 49A engages a ledge 35B formed in the opening 35A so as to prevent movement of the second lever 48 in the opposite pivoting or rotational direction, thus keeping the first lever 42 in the locked position and thus the plunger rod 60 in the locked arrangement.

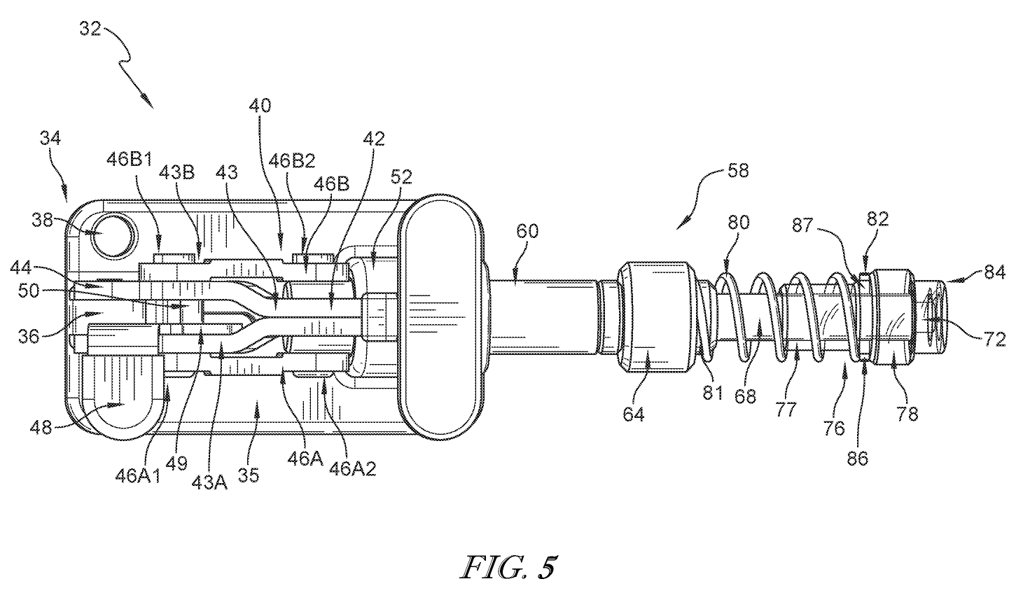

As shown in FIGS. 2 and 5-8, the plunger rod 60 includes a support portion 64 having a support surface 65 that faces a forwardmost end 73 of the plunger rod 60. The plunger rod 60 further includes a distal portion 68 that extends away from the support surface 65 of the support portion 64. Illustratively, the support portion 64 may be formed as an annular flange that extends outwardly away from the plunger rod 60, as can be seen in FIGS. 5-8. The distal portion 68 of the plunger rod 60 extends away from a central portion of the support surface 65 of the support portion 64 such that an area of the support surface 65 outward of the central portion defines the area on which a spring 80 is coupled.

The plunger rod 60 further includes the spring 80 coupled to the spring-loaded rod 76 and configured to bias the spring-loaded rod 76 in the forward direction 90 and forward of the forwardmost end 73 of the plunger rod 60 in the unlocked arrangement, this being shown in FIG. 7. A first end 81 of the spring 80 is coupled to and supported against the support surface 65, and the spring-loaded rod 76 is arranged on a second end 82 of the spring 80 opposite the first end 81.

Illustratively, the spring-loaded rod 76 includes an inner portion 77 and an end portion 78 that extends radially outwardly from an outer surface of the inner portion 77, as shown in FIGS. 7 and 8. The end portion 78 and the inner portion can be cylindrical, and the end portion 78 has a greater diameter than the inner portion 77 such that the end portion 78 defines a surface facing the base 35 on which the second end 82 is coupled. The plunger rod 60 is also cylindrical, and the distal portion 64 has a small diameter than the diameter of the inner and end portions 77, 78 of the spring-loaded plunger 76, as shown in FIGS. 7 and 8.

The inner portion 77 includes a central cavity 77A that extends through the spring-loaded rod 76. The distal portion 68 of the plunger rod 60 extends through the cavity 77A such that the spring-loaded rod 76 is slidable relative to the distal portion 68. The spring-loaded rod 76 is coaxial with the distal portion 68 and is movable relative to the distal portion 68. In some embodiments, the end portion 78 includes an end cap 84 extending forwardly therefrom, which also is hollow so the distal portion 68 can extend therethrough when the plunger rod 60 is in the unlocked arrangement. The end cap 84 defines a forwardmost end 85 of the plunger rod 60, and the forwardmost end 85 may be open, in particular having an opening (i.e. a forward opening) that aligns with the central cavity 77A. In some embodiments, when in the unlocked arrangement, the forwardmost end 73 of the plunger rod 60 is arranged within the end cap 84, as shown in FIG. 7.

This configuration of the spring-loaded rod 76 on the plunger rod 60 allows for the spring-loaded rod 76 to move in the rearward direction 92 when the plunger clamp 32 is pressed against the workpiece 12, and the biasing of the spring 80 provides some force on the workpiece 12 to keep it generally in the same position, but to still allow for some play or adjustment of the workpiece 12 relative to the plunger clamp 32 and the shaft 16. In order to prevent the spring 80 from biasing the spring-loaded rod 76 too far forward and off of the forwardmost end 73 of the plunger rod 60, the distal portion 68 includes at least one elongated opening 87 formed therein that extend diametrically across the diameter of the distal portion 68. The spring-loaded rod 76 includes at least one pin 86 that extends through the at least one elongated opening 85. The at least one elongated opening 85 is sized so as to delimit movement of the spring- loaded rod 76 in the forward direction 90 as the spring-loaded rod 76 is biased by the spring 80.

Once the workpiece 12 is in the desired final position, the plunger rod 60 can be moved via the lever 42 into the locked arrangement in which the forwardmost end 73 of the plunger rod 60 is moved forward and engages the workpiece 12, as shown in FIG. 8. Illustratively, the forwardmost end 73 of the plunger rod 60 includes a tip 72 which can be formed of plastic, neoprene, rubber, or a similar material to allow for some very minor compression to account for the locked arrangement of the plunger rod 60 extending too far forward and exerting too much force on the workpiece 12. Similarly, the end tip 84A of the end cap 84 may also be formed of plastic, neoprene, rubber, or a similar material so as to allow for some compression of the spring-loaded rod 76 when pressed against the workpiece 12.

Having both the tip 72 and the end tip 84A being made of these materials may provide benefits in PECM machining since loads are not imposed on the workpiece 12 during machining. In other embodiments, only of the tip 72 and the end tip 84 includes one of these materials, and in some embodiments, neither of the tip 72 and the end tip 84 includes one of these materials. Having only one or none include these materials may be advantageous in machining applications in which aggressive loads are imposed on the workpiece 12 during machining, and thus very high strength of the workpiece 12 holding means (i.e. the plunger clamp 32) is required.

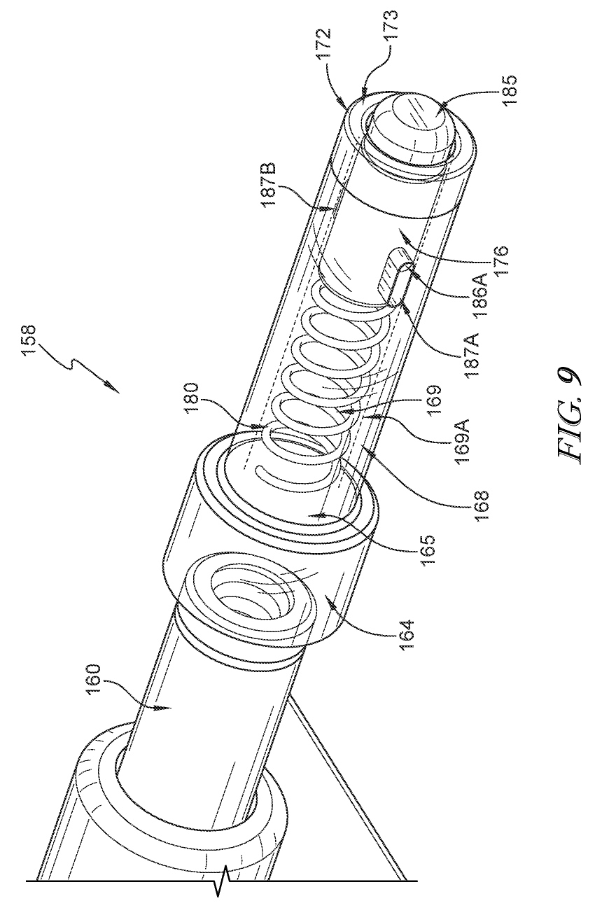

Another embodiment of a plunger rod 160 that can be utilized with the plunger clamp 32 described above is shown in FIGS. 9-11. The plunger rod 160 is similar to the plunger rod 60 shown in FIGS. 1-8 and described herein. Accordingly, similar reference numbers in the 100 series indicate features that are common between the plunger rod 60 and the plunger rod 160. The description of the plunger rod 60 is incorporated by reference to apply to the plunger rod 160, except in instances when it conflicts with the specific description and the drawings of the plunger rod 160.

The plunger rod 160 differs from the plunger rod 60 in that, instead of the spring-loaded rod 76 being surrounding the distal end 68 of the plunger rod 60, the spring-loaded rod 176 is arranged within a cavity 169 formed in the distal end 168 of the plunger rod 160. As can be seen in FIGS. 9-11, the plunger 160 includes a support portion 164 which has a greater diameter than the distal portion 168 extending from a support surface 165 of the support portion 164. The cavity 169 can be cylindrical and extends from the support surface 165 to a forwardmost end 173 of the plunger rod 160 and opens outwardly from the forwardmost end 173. The spring-loaded rod 176 is cylindrical and configured to slidably move within the cavity 169, in particular along the inner annular surface 169A of the cavity 169.

As shown in FIGS. 9-11, the spring 180 is arranged within the cavity 169 and includes a first end 181 coupled to and supported against the support surface 165 and a second end 182 opposite the first end 181 that is arranged on the spring-loaded rod 176 such that the spring 180 biases the spring-loaded rod 176 forward. Forward movement of the spring-loaded rod 176 is delimited by diametrically opposing pins 186A extending away from the outer surface of the spring-loaded rod 176 (the opposing pin is not shown but formed the same as 186A on the opposite side of the rod 176) and through elongated grooves 187A, 187B formed in the distal portion 168 of the plunger rod 160 (the opposing groove 187B is barely shown but formed the same as 187A on the opposite side of the distal portion 168 of the plunger rod 160).

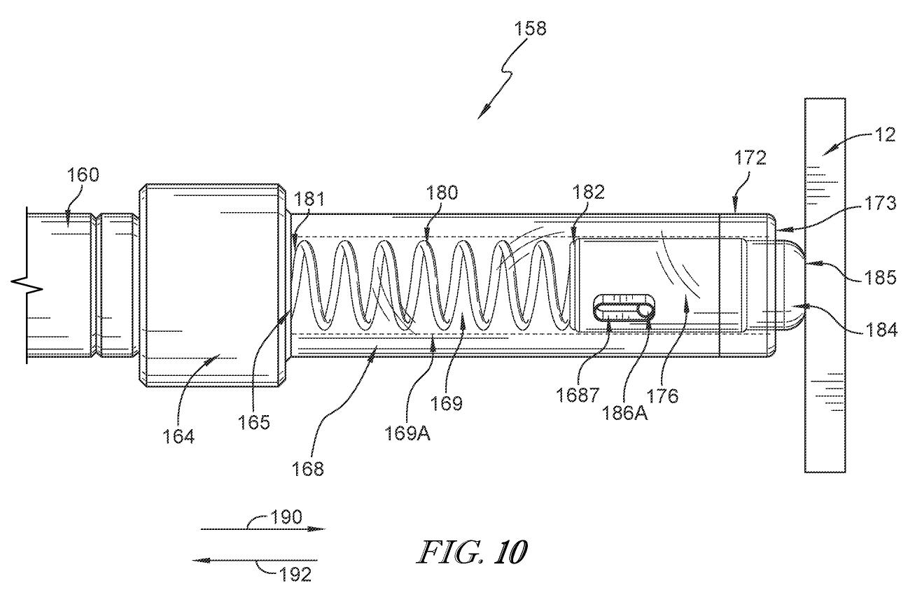

In the unlocked arrangement of the plunger rod 160, as shown in FIG. 10, the spring-loaded rod 176 extends outwardly from the cavity 169 forward of a forwardmost end 185 of the distal portion 168 of the plunger rod 160. The spring-loaded rod 176 extending outwardly in this manner allows for the spring- loaded rod 176 to move in the rearward direction 192 when the plunger clamp 32 is pressed against the workpiece 12, and the biasing of the spring 180 provides some force on the workpiece 12 to keep it generally in the same position, but to still allow for some play or adjustment of the workpiece 12 relative to the plunger clamp 32 and the shaft 16.

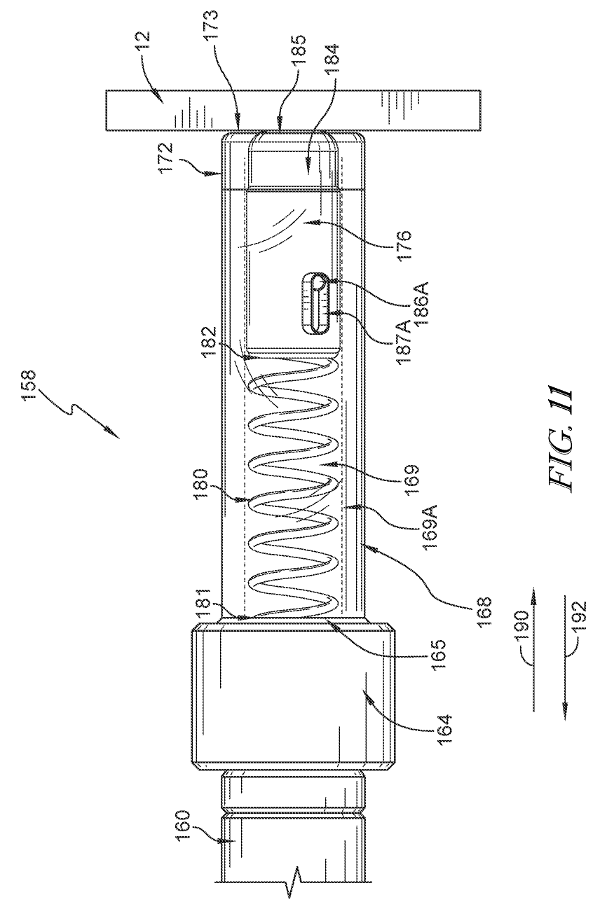

Once the workpiece 12 is in the desired final position, the plunger rod 160 can be moved in the forward direction 190 via the lever 42 into the locked arrangement in which the forwardmost end 173 of the plunger rod 160 is moved forward and engages the workpiece 12, as shown in FIG. 11. Illustratively, the forwardmost end 173 of the plunger rod 160 includes a tip 172 which can be formed of plastic, neoprene, rubber, or a similar material to allow for some very minor compression to account for the locked arrangement of the plunger rod 160 extending too far forward and exerting too much force on the workpiece 12. Similarly, the forwardmost end 185 of the distal portion 168 may also be formed of plastic, neoprene, rubber, or a similar material so as to allow for some compression of the spring-loaded rod 176 when pressed against the workpiece 12.

Similar to the plunger clamp 32, having both the tip 172 and the forwardmost end 185 being made of these materials may provide benefits in PECM machining since loads are not imposed on the workpiece 12 during machining. In other embodiments, only of the tip 172 and the forwardmost end 185 includes one of these materials, and in some embodiments, neither of the tip 172 and the forwardmost end 185 includes one of these materials. Having only one or none include these materials may be advantageous in machining applications in which aggressive loads are imposed on the workpiece 12 during machining, and thus very high strength of the workpiece 12 holding means (i.e. the plunger clamp 32) is required.

As described above, a method of positioning the workpiece 12 utilizing the tool base 18 described above includes providing the workpiece 12, providing the machine 14 configured to modify the workpiece 12, and arranging the workpiece 12 in the first support frame 22 of a tool base 18. The workpiece 12 is allowed some play relative to the machine 14 when only arranged in the first support frame 22. The tool base 18 includes the first support frame 22 and a second support frame 28 that is repositionable relative to the first support frame 22 and including a plunger clamp 32 coupled thereto, the plunger clamp 32 including a clamp base 35, a plunger rod 60 movably supported by the clamp base 35, and a spring-loaded rod 76 that is movable relative to the plunger rod 60.

The method further includes selectively moving the plunger rod 60 to an unlocked arrangement in which a forwardmost end 85 of the spring-loaded rod 76 is positioned forward of a forwardmost end 73 of the plunger rod 60. The method further includes moving the second support frame 28 proximal to the first support frame 22 such that the forwardmost end 85 of the spring-loaded rod 76 contacts the workpiece 12 while allowing for some play of the workpiece 12 relative to the machine 14. The method further includes selectively moving the plunger rod 60 to a locked arrangement in which forwardmost end 73 of the plunger rod 60 is moved forward and contacts the workpiece 12 to lock the workpiece 12 in an immovable position relative to the machine 14. In some embodiments, the method can further include, prior to moving the second support frame 28 proximal to the first support frame 22 such that the forwardmost end 85 of the spring-loaded rod 76 contacts the workpiece 12, adjusting at least one of a position of the first support frame 22 or a position of the workpiece 12 within the first support frame 22 such that the workpiece 12 is arranged in a first position relative to the machine 14.

In some embodiments, the method can further include, prior to moving the second support frame 28 proximal to the first support frame 22 such that the forwardmost end 85 of the spring-loaded rod 76 contacts the workpiece 12, adjusting at least one of a position of the first support frame 22 or a position of the workpiece 12 within the first support frame 22 such that the workpiece 12 is arranged in a first position relative to the machine 14. In some embodiments, the method can further include, after moving the second support frame 28 proximal to the first support frame 22 such that the forwardmost end 85 of the spring-loaded rod 76 contacts the workpiece 12, further adjusting at least one of a position of the first support frame 22 or a position of the workpiece 12 within the first support frame 22 such that the workpiece 12 is arranged in a second position relative to the machine. The selective moving of the plunger rod 60 to the locked arrangement occurs after the workpiece 12 has been adjusted to the second position.

In some embodiments, the method further includes locking the first support frame 22 on the base platform 20 after moving the first support frame 22 to a desired position relative to the shaft 16. The method further includes, after moving the second support frame 28 proximal to the first support frame 22 such that the forwardmost end 85 of the spring-loaded rod 76 contacts the workpiece 12, locking the second support frame 28 on the base platform 20.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising
a thin-walled three-dimensional workpiece,
a machine configured to modify the thin-walled three-dimensional workpiece, the machine including a shaft configured to move along a first axis, and
a tool base configured to support the thin-walled three-dimensional workpiece and spaced apart from the shaft along the first axis and repositionable relative to the shaft, wherein the shaft is movable relative to the tool base so as to modify the thin-walled three-dimensional workpiece, the tool base including a base platform, a first support frame that is repositionable on the base platform and configured to support the thin-walled three-dimensional workpiece above the base platform, and a second support frame that is repositionable on the base platform, the second support frame including a plunger clamp coupled thereto, the plunger clamp including a clamp base, a plunger rod movably supported by the clamp base and extending away from the clamp base, the plunger rod being selectively movable toward and away from the clamp base, the plunger clamp further including a spring-loaded rod that is movable relative to the plunger rod, a forwardmost end of the spring-loaded rod extending forward of a forwardmost end of the plunger rod in response to the plunger rod being in an unlocked arrangement,
wherein the second support frame is configured to be repositioned adjacent to the first support frame such that the plunger clamp contacts the thin- walled three-dimensional workpiece and provides support thereto, wherein, in response to the plunger rod being selectively moved to the unlocked arrangement, the forwardmost end of the spring-loaded rod contacts the thin- walled three-dimensional workpiece while allowing for some play of the thin- walled three-dimensional workpiece relative to the tool base so as to allow for adjustments of the thin-walled three-dimensional workpiece relative to the shaft of the machine, and wherein, in response to the plunger rod being selectively moved to a locked arrangement, the forwardmost end of the plunger rodis moved forward and contacts the thin-walled three dimensional workpiece to lock the thin-walled three dimensional workpiece in an immovable position relative to the shaft of the machine.

2. The machine tool system of claim 1, wherein the plunger rod further includes a spring coupled to the spring-loaded rod and configured to bias the spring-loaded rod forward of the forwardmost end of the plunger rod in the unlocked arrangement.

3. The machine tool system of claim 2, wherein the plunger rod further includes a support portion having a support surface that faces the forwardmost end of the plunger rod, wherein a first end of the spring is coupled to and supported against the support surface, and wherein the spring-loaded rod is arranged on a second end of the spring opposite the first end.

4. The machine tool system of claim 3, wherein the plunger rod includes a distal portion that extends away from the support portion, and wherein the spring-loaded rod is coaxial with the distal portion and is movable relative to the distal portion.

5. The machine tool system of claim 4, wherein the distal portion includes at least one elongated opening formed therein, wherein the spring-loaded rod includes at least one pin that extends through the at least one elongated opening, and wherein the at least one elongated opening is sized so as to delimit movement of the spring-loaded rod in a forward direction as the spring-loaded rod is biased by the spring.

6. The machine tool system of claim 4, wherein the support portion is formed as an annular flange that extends outwardly away from the plunger rod, and wherein the distal portion of the plunger rod extends away from a central portion of the support surface of the support portion such that an area of the support surface outward of the central portion defines the area on which the spring is coupled.

7. The machine tool system of claim 6, wherein the spring- loaded rod includes a central cavity extending through the spring-loaded rod and through which the distal portion of the plunger rod extends, and wherein the spring-loaded rod is slidable relative to the distal portion.

8. The machine tool system of claim 7, wherein the forwardmost end of the plunger rod is a forwardmost end of the distal portion, wherein the spring-loaded rod includes a forward opening aligned with the central cavity, wherein the forwardmost end of the distal portion extends through the forward opening in response to the plunger rod being moved to the locked arrangement, and wherein the forwardmost end of the distal portion is arranged within the central cavity of the spring-loaded rod rearward of the forward opening in response to the plunger rod being in the unlocked arrangement.

9. The machine tool system of claim 4, wherein the distal portion of the plunger rod extends away from the support surface of the support portion and includes a central cavity extending through the distal portion from the support surface to a forwardmost end of the distal portion and opening at a forward opening located at the forwardmost end, and wherein the spring-loaded rod is arranged within the central cavity and is slidable therein.

10. The machine tool system of claim 9, wherein the forwardmost end of the spring-loaded rod extends outwardly from the central cavity of the distal portion forward of the forward opening of the distal portion in response to the plunger rod being in the unlocked arrangement.

11. The machine tool system of claim 2, wherein the plunger clamp further includes a lever configured to move the plunger rod away from and toward the clamp base, and wherein the lever is selectively movable between an unlocked position which moves the plunger rod to the unlocked arrangement and a locked position which moves the plunger rod to the locked arrangement.

12. A machine tool system comprising
a workpiece,
a machine configured to modify the workpiece, and
a tool base configured to support the workpiece relative to the machine and repositionable relative to the machine, the tool base including a first support frame supporting the workpiece and a second support frame that is repositionable relative to the first support frame and including a plunger clamp coupled thereto, the plunger clamp including a clamp base, a plunger rod movably supported by the clamp base, and a spring-loaded rod that is movable relative to the plunger rod,
wherein, in response to the plunger rod being selectively moved to an unlocked arrangement, only a forwardmost end of the spring-loaded rod contacts the workpiece while allowing for some play of the workpiece relative to the machine, and wherein, in response to the plunger rod being selectively moved to a locked arrangement, a forwardmost end of the plunger rod is moved forward and contacts the workpiece to lock the workpiece in an immovable position relative to the machine.

13. The machine tool system of claim 12, wherein the forwardmost end of the spring-loaded rod extends forward of the forwardmost end of the plunger rod in response to the plunger rod being in the unlocked arrangement.

14. The machine tool system of claim 13, wherein the plunger rod further includes a support portion having a support surface that faces the forwardmost end of the plunger rod, wherein a first end of the spring is coupled to and supported against the support surface, wherein the spring-loaded rod is arranged on a second end of the spring opposite the first end, wherein the plunger rod includes a distal portion that extends away from the support portion, and wherein the spring-loaded rod is coaxial with the distal portion and is movable relative to the distal portion.

15. The machine tool system of claim 14, wherein the support portion is formed as an annular flange that extends outwardly away from the plunger rod, wherein the distal portion of the plunger rod extends away from a central portion of the support surface of the support portion such that an area of the support surface outward of the central portion defines the area on which the spring is coupled, wherein the spring-loaded rod includes a central cavity extending through the spring-loaded rod and through which the distal portion of the plunger rod extends, and wherein the spring-loaded rod is slidable relative to the distal portion.

16. The machine tool system of claim 16, wherein the forwardmost end of the plunger rod is a forwardmost end of the distal portion, wherein the spring-loaded rod includes a forward opening aligned with the central cavity, wherein the forwardmost end of the distal portion extends through the forward opening in response to the plunger rod being moved to the locked
arrangement, and wherein the forwardmost end of the distal portion is arranged within the central cavity of the spring-loaded rod rearward of the forward opening in response to the plunger rod being in the unlocked arrangement.

17. The machine tool system of claim 14, wherein the distal portion of the plunger rod extends away from the support surface of the support portion and includes a central cavity extending through the distal portion from the support surface to a forwardmost end of the distal portion and opening at a forward opening located at the forwardmost end, wherein the spring-loaded rod is arranged within the central cavity and is slidable therein, and wherein the forwardmost end of the spring-loaded rod extends outwardly from the central cavity of the distal portion forward of the forward opening of the distal portion in response to the plunger rod being in the unlocked arrangement.

18. A method comprising
providing a workpiece,
providing a machine configured to modify the workpiece,
arranging the workpiece in a first support frame of a tool base,
wherein the workpiece is allowed some play relative to the machine when only arranged in the first support frame, the tool base including the first support frame and a second support frame that is repositionable relative to the first support frame and including a plunger clamp coupled thereto, the plunger clamp including a clamp base, a plunger rod movably supported by the clamp base, and a spring-loaded rod that is movable relative to the plunger rod,
selectively moving the plunger rod to an unlocked arrangement in which a forwardmost end of the spring-loaded rod is positioned forward of a forwardmost end of the plunger rod,
moving the second support frame proximal to the first support frame such that the forwardmost end of the spring-loaded rod contacts the workpiece while allowing for some play of the workpiece relative to the machine, and
selectively moving the plunger rod to a locked arrangement in which forwardmost end of the plunger rod is moved forward and contacts the workpiece to lock the workpiece in an immovable position relative to the machine.

19. The method of claim 18, further comprising:
prior to moving the second support frame proximal to the first support frame such that the forwardmost end of the spring-loaded rod contacts the workpiece, adjusting at least one of a position of the first support frame or a position of the workpiece within the first support frame such that the workpiece is arranged in a first position relative to the machine.

20. The method of claim 19, further comprising:
after moving the second support frame proximal to the first support frame such that the forwardmost end of the spring-loaded rod contacts the workpiece, further adjusting at least one of a position of the first support frame or a position of the workpiece within the first support frame such that the workpiece is arranged in a second position relative to the machine,
wherein the selective moving of the plunger rod to the locked arrangement occurs after the workpiece has been adjusted to the second position.
